(19) United States
(12) Patent Application Publication
(10) Pub. No.: US 2026/0319441 A1
(43) Pub. Date: Oct. 15, 2026

(54) Digital clock

(71) Applicant: Shenzhen Blue Rainbow Optoelectronics Technology Co., Ltd., Shenzhen (CN)

(72) Inventor: Yelin Gong, Fuzhou (CN)

(21) Appl. No.: 19/176,008

(22) Filed: Apr. 10, 2025

(51) Int. Cl. G04C 17/00

(52) U.S. Cl. CPC G04C 17/00

(57) ABSTRACT

The present application discloses a digital clock, comprising a dial; a display mechanism, the display mechanism is arranged at the front end of the dial and is used to display information; an inner frame, the dial is arranged at the front end of the inner frame; a control system, the control system is arranged in the inner frame, connected to the display mechanism through a line, and is used to control the operation of the display mechanism; a power supply interface, the power supply interface is arranged on the side wall of the inner frame, and is connected to the control system through a line.

### FILD OF THE APPLICATION

The present application relates to the technical field of digital clocks, and in particular to a digital clock.

### BACKGROUND

In today's society, clocks serve as essential timekeeping tools across various fields. Traditional digital clocks typically use liquid crystal displays (LCDs) or light-emitting diodes (LEDs) to show the time. Although these clocks have advantages like clear displays and low costs, they often lack elements of fun, technological appeal, and decorative value. As people's living standards improve and the demand for personalized products rises, traditional digital clocks are increasingly failing to meet consumers' aesthetic preferences and practical needs.

Traditional digital clocks typically have simple functions, mainly focusing on basic time display, and they often lack user interaction capabilities. In the realms of smart homes and smart offices, users are increasingly demanding more advanced features from clocks. They desire functionalities such as voice control and network-based time synchronization to enhance convenience and intelligence.

To address these issues, a new digital clock has been designed.

### SUMMARY

The technical problem the present invention aims to solve is to overcome the defects of the above-mentioned technology and provide a digital clock.

In order to solve the above technical problems, the technical solution provided by the present invention is a digital clock. A digital clock, comprising a dial, a display mechanism, an inner frame and a control system; wherein the display mechanism is arranged at the front end of the dial for displaying information; wherein the dial is arranged at the front end of the inner frame; and the control system is arranged in the inner frame and connected to the display mechanism through a line to control the operation of the display mechanism.

The display mechanism comprising a digital component, dot components and a driver board; wherein the two dot components are provided in the middle of the front end of the dial; the two dot components are symmetrically arranged up and down; wherein the four digital components are provided at the front end of the dial and are symmetrically arranged on both sides of the two dot components; and the two driver boards are symmetrically provided at the top of the inner frame; the driver board is located at the rear end of the dial; wherein each of the driver boards is connected to the two digital components on the same side through a line; and each of the driver boards is connected to a dot component through a line.

The digital assembly comprising seven first motors and a first display board; wherein the first motors are arranged at the front end of the dial, and the seven first motors are arranged in an 8-shaped shape; the rotating shafts of the first motors are all provided with a support, and the support is provided with a first display board; wherein the first motors are connected to the corresponding drive boards through lines.

The dot assembly comprising a second motor and a second display board; wherein the second motor is arranged in the middle of the front end of the dial; and a support plate board is arranged on the rotating shaft of the second motor; wherein the support plate board is provided with a second display board; the second motor is connected to the corresponding driving plate through a circuit.

The control system comprising a development board, a clock module and a voice control module, and the development board is connected to the clock module and the voice control module through lines.

An outer frame, which is arranged outside the inner frame and the dial, and a back cover is arranged at the rear end of the outer frame; wherein one end of the power interface extends out of the outer frame; wherein a power adapter that plugs into a power interface to power the device.

The advantages of the present invention compared with the prior art are:

### 1. The Mechanical Dynamic Display Enhances Interest and Appreciation

This digital clock utilizes 30 small motors to drive the main display panel, which shows the numbers. Additionally, it employs two secondary motors to operate the second display board, which serves as a separator dot for the time. The time changes are achieved through a physical flipping mechanism. Compared to traditional LCD or LED display methods, this clock offers a stronger visual impact and a more advanced technological feel. It successfully combines modern technology with retro mechanical aesthetics, resulting in a unique visual experience that caters to users'desires for personalized products.

### 2. Intelligent Interactive Function

Equipped with a voice control module, users can easily set the time and adjust the display using voice commands. This feature enhances human-computer interaction and improves overall convenience. Additionally, the development board can connect to Wi-Fi to obtain accurate time, ensuring the clock remains precise. Even if the network connection is lost, the clock module will continue to provide time, allowing the clock to function normally.

### 3. Modular Design Simplifies Maintenance

The various components, such as the dial, inner frame, outer frame, control system, and power supply, are designed in a modular way. This design makes production, assembly, and repairs easier. For instance, if a motor or display panel malfunctions, it can be easily replaced, which reduces both maintenance costs and difficulties.

### BRIEF DESCRIPTION OF THE DRAWINGS

FIG. 1 is a front view of a digital clock of the present invention.

FIG. 2 is a schematic diagram of the front stereoscopic structure of a digital clock of the present invention.

FIG. 3 is a schematic diagram of the rear stereoscopic structure of a digital clock of the present invention.

FIG. 4 is a rear view of a digital clock of the present invention in a disassembled state.

FIG. 5 is a schematic diagram of the upward stereoscopic structure of a digital clock of the present invention in a disassembled state.

FIG. 6 is a schematic diagram of the top stereoscopic structure of a digital clock of the present invention in a disassembled state.

FIG. 7 is a schematic diagram of the clock motor of a digital clock of the present invention.

FIG. 8 is a schematic diagram of the clock motor of a digital clock of the present invention.

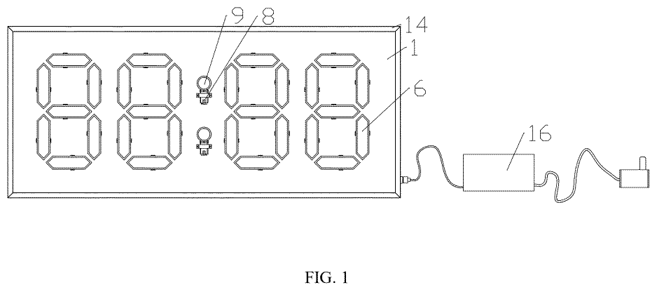

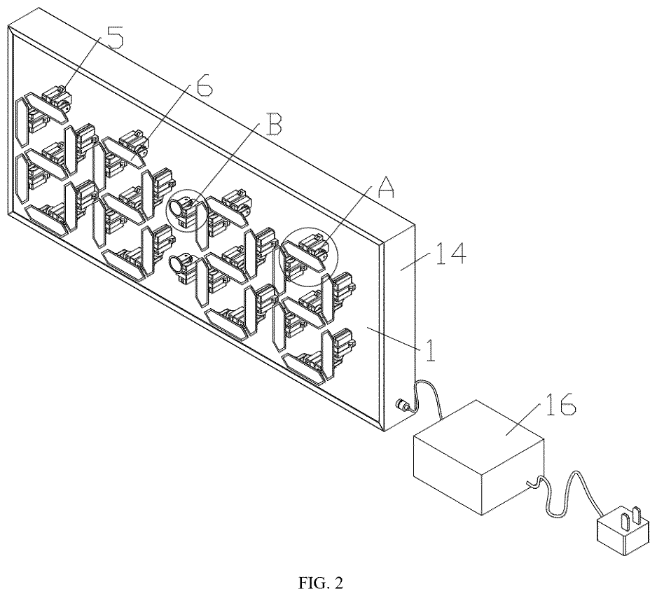

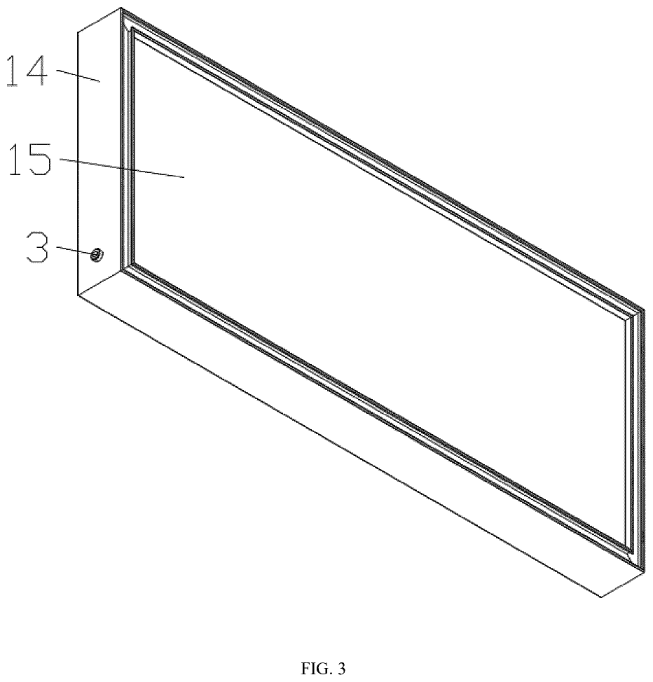

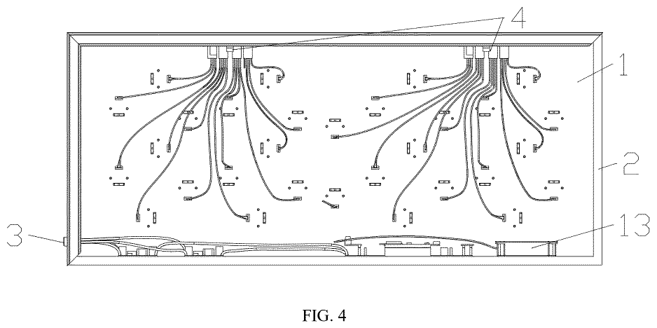

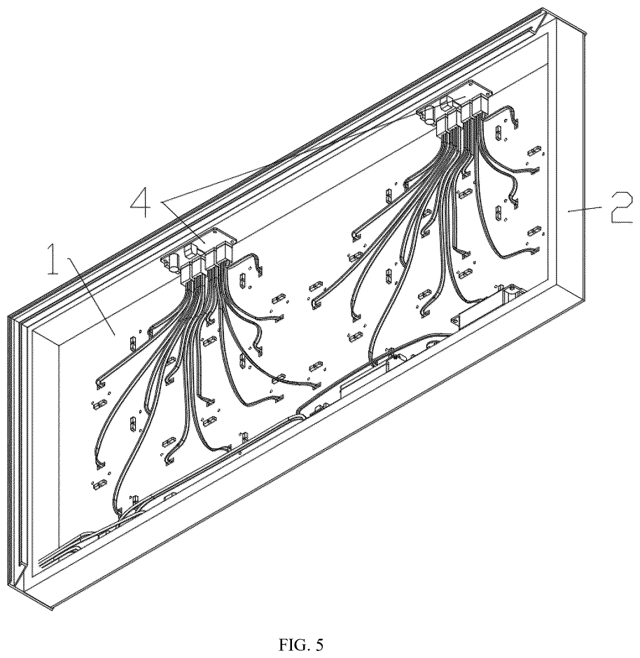

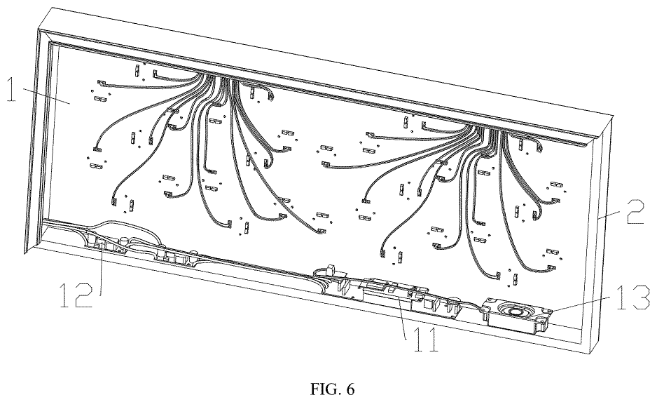

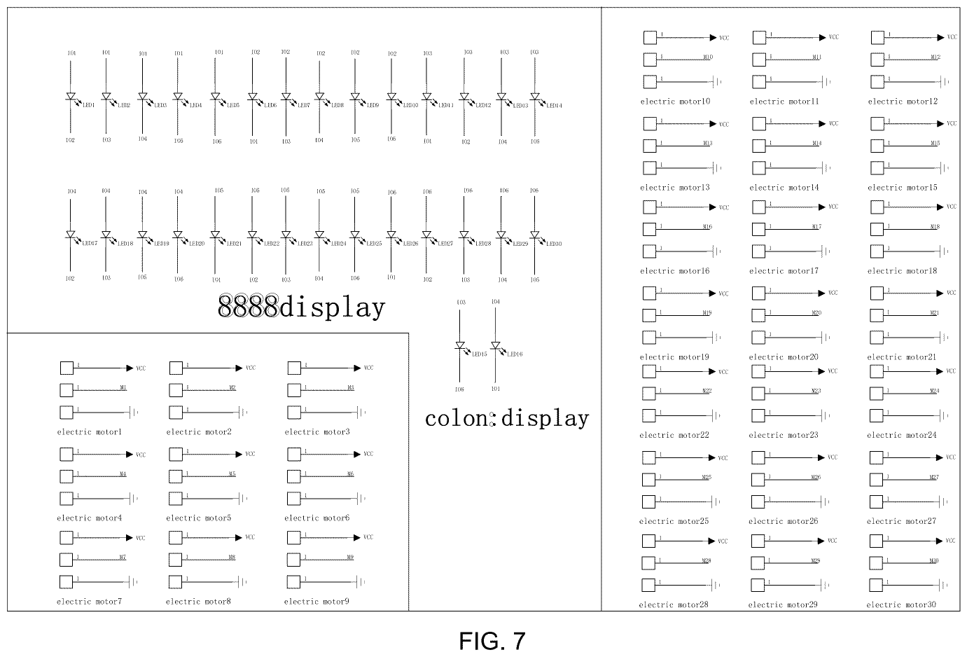

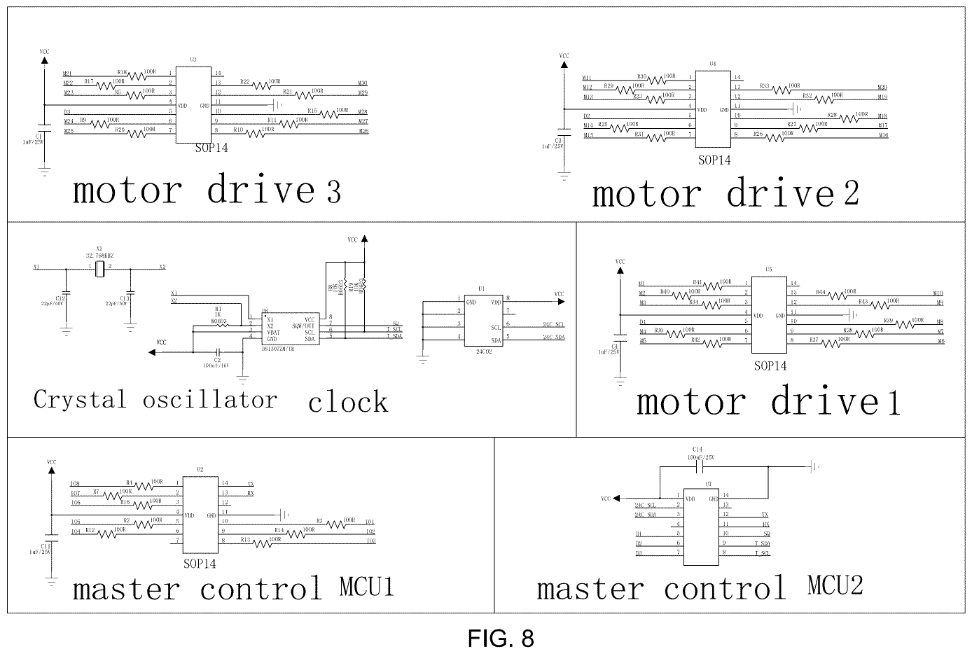

As shown in FIGS. 1-8:
1. dial,
2. inner frame,
3. power interface,
4. driver board,
5. first motor,
6. first display board,
7. support,
8. second motor,
9. second display board,
10. support board,
11. development board,
12. clock module,
13. voice control module,
14. outer frame,
15. back cover,
16. power adapter

While the technology is susceptible to various modifications and alternative forms, specifics thereof have been shown by way of example and drawings, and will be described in detail. It should be understood, however, that the application is not limited to the particular embodiments described. On the contrary, the application is to cover modifications, equivalents, and alternatives falling within the spirit and scope of the technology.

### DETAILED DESCRIPTION OF EMBODIMENTS

The embodiments of the present technology described herein are not intended to be exhaustive or to limit the technology to the precise forms disclosed in the following detailed description. Rather, the embodiments are chosen and described so that others skilled in the art can appreciate and understand the principles and practices of the present technology.

All publications and patents mentioned herein are hereby incorporated by reference. The publications and patents disclosed herein are provided solely for their disclosure. Nothing herein is to be construed as an admission that the inventors are not entitled to antedate any publication and/or patent, including any publication and/or patent cited herein.

As shown in FIG. 1-8, a digital clock, comprising a dial 1, a display mechanism, an inner frame and a control system; wherein the display mechanism is arranged at the front end of the dial 1 for displaying information; wherein the dial 1 is arranged at the front end of the inner frame 2; and the control system is arranged in the inner frame 2 and connected to the display mechanism through a line to control the operation of the display mechanism. The power interface 3 is arranged on the side wall of the inner frame 2 and is connected to the control system through a line.

The display mechanism includes a digital component, a dot component and a driver board 4. Two dot components are provided at the middle of the front end of the dial 1. The two dot components are symmetrically arranged up and down. Four digital components are provided at the front end of the dial 1 and are symmetrically arranged on both sides of the two dot components. Two driver boards 4 are symmetrically provided at the top of the inner frame 2. The driver board 4 is located at the rear end of the dial 1. Each of the driver boards 4 is connected to the two digital components on the same side through a line, and each of the driver boards 4 is connected to a dot component through a line.

The digital component includes seven first motors 5 and a first display board 6. The first motors 5 are arranged at the front end of the dial 1, and the seven first motors 5 are arranged in an 8-shape. The first motors 5 can be fixed by glue, screws, etc., so that the first motors 5 are stably fixed on the dial 1. The rotating shafts of the first motors 5 are provided with supports 7, and the supports 7 are provided with first display boards 6. The first motors 5 are connected to the corresponding driver boards 4 through lines. The corresponding first motors 5 are controlled by the driver boards 4 to switch and rotate back and forth between 90 degrees and −90 degrees, driving the first display boards 6 to flip to a horizontal state or a vertical state, thereby adjusting the display and hiding states of different first display boards 6 to achieve the functions of displaying time and adjusting time.

The dot assembly includes a second motor 8 and a second display board 9. The second motor 8 is arranged in the middle of the front end of the dial 1. The second motor 8 can be fixed by glue, screws, etc., so that the second motor 8 is stably fixed on the dial 1. A support plate board 10 is provided on the rotating shaft of the second motor 8. The support plate board 10 is provided with a second display board 9. The second motor 8 is connected to the corresponding driving plate 4, through a circuit. The corresponding second motor is controlled by the driving plate 4 to switch and rotate back and forth between 90 degrees and −90 degrees, driving the second display board 9 to flip to a horizontal state or a vertical state, thereby adjusting different display conditions of the clock.

The first motor 5 and the second motor 8 can be specifically made of servos, ordinary motors, stepper motors, etc., as long as they can execute commands to rotate;

The control system includes a development board 11, which uses a development board 11 as the main control of the clock and connects to wifi to obtain time.

The clock module 12 is responsible for timing the clock when the network is disconnected;

The voice control module 13 is used for voice interaction, which facilitates the user to control the clock by voice;

The development board 11 is connected to the clock module 12 and the voice control module 13 through lines, so that commands can be transmitted and executed.

The outer frame 14 is arranged outside the inner frame 2 and the dial 1. A back cover 15 is provided at the rear end of the outer frame 14 to protect the components of the entire clock and also to increase the aesthetics of the clock. One end of the power interface 3 extends out of the outer frame 14.

The power adapter 16 is plugged into the power interface 3 and uses a 5V10A power adapter 3 to provide power to the device.

In the specific implementation of the present invention, first, the 5V10A power adapter 16 is connected to the power supply, and then the plug of the power adapter 16 is plugged into the power interface 3; the clock is powered.

Get time from the Internet: Connect the development board 11 to Wi-Fi to get accurate time information from the Internet.

Time display: The development board 11 sends control signals to the two drive boards 4 according to the acquired time information. The two drive boards 4 respectively, control the corresponding first motor 5 and second motor 8 to rotate so that the first display board 6 and the second display board 9 display the corresponding numbers and time separation dots to realize the display of time.

Users can set different dynamic effects through the development board 11, such as displaying countdown, date, pause, etc. In actual operation, they can also combine multimedia elements such as light and sound to further enhance the fun and viewing of the clock.

Voice control: When the voice control module 13 receives the user's voice command, it sends the command to the development board 11; the development board 11 converts the voice command into the time information to be displayed, and then sends the control signal to the driver board 4, which controls the first motor 5 and the second motor 8 to perform corresponding actions to realize voice control of the clock.

Offline timing: When the network is disconnected, the clock module 12 provides time information to the development board 11 to ensure that the clock can continue to display the time normally.

1. A digital clock, comprising a dial, a display mechanism, an inner frame and a control system; wherein the display mechanism is arranged at the front end of the dial for displaying information; wherein the dial is arranged at the front end of the inner frame; and the control system is arranged in the inner frame and connected to the display mechanism through a line to control the operation of the display mechanism; wherein the power interface is arranged on the side wall of the inner frame and is connected to the control system through a line.

2. The digital clock of claim 1, wherein the display mechanism comprising a digital component, dot components and a driver board; wherein the two dot components are provided in the middle of the front end of the dial; the two dot components are symmetrically arranged up and down; wherein the four digital components are provided at the front end of the dial and are symmetrically arranged on both sides of the two dot components; and the two driver boards are symmetrically provided at the top of the inner frame; the driver board is located at the rear end of the dial; wherein each of the driver boards is connected to the two digital components on the same side through a line; and each of the driver boards is connected to a dot component through a line.

3. The digital clock of claim 2, wherein the digital assembly comprising seven first motors and a first display board; wherein the first motors are arranged at the front end of the dial, and the seven first motors are arranged in an 8-shaped shape;
the rotating shafts of the first motors are all provided with a support, and the support is provided with a first display board; wherein the first motors are connected to the corresponding drive boards through lines.

4. The digital clock of claim 2, wherein the dot assembly comprising a second motor and a second display board; wherein the second motor is arranged in the middle of the front end of the dial; and a support plate board is arranged on the rotating shaft of the second motor; wherein the support plate board is provided with a second display board; the second motor is connected to the corresponding driving plate through a circuit.

5. The digital clock of claim 1, wherein the control system comprising a development board, a clock module and a voice control module, and the development board is connected to the clock module and the voice control module through lines.

6. The digital clock of claim 1, wherein, comprising an outer frame, which is arranged outside the inner frame and the dial, and a back cover is arranged at the rear end of the outer frame; wherein one end of the power interface extends out of the outer frame; wherein a power adapter that plugs into a power interface to power the device.
